(19) United States
(12) Patent Application Publication
(10) Pub. No.: US 2026/0228599 A1
(43) Pub. Date: Aug. 6, 2026

(54) SYSTEMS AND METHODS FOR FINE-TUNING A MACHINE LEARNING MODEL OF AN AUTONOMOUS VEHICLE DURING SPECIFIC EVENTS

(71) Applicants: Constructor Technology AG, Schaffhausen (CH); Constructor Education and Research Genossenschaft, Schaffhausen (CH)

(72) Inventors: Ilya SHIMCHIK, Zurich (CH); Ruslan MUSTAFIN, Tbilisi (GE); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/040,223

(22) Filed: Jan. 29, 2025

(51) Int. Cl. G06N 20/00; B60W 60/00; G01C 21/34

(52) U.S. Cl. CPC G06N 20/00; B60W 60/001; G01C 21/3415

(57) ABSTRACT

A system monitors a vehicle navigating in an environment using a pre-trained machine learning model that is configured to make navigation decisions during autonomous driving of the vehicle. The system identifies a first simulated trajectory generated by the pre-trained machine learning model and a first real trajectory driven by the vehicle. In response to determining that a trajectory type of the first real trajectory is one of a plurality of trajectory types that trigger fine-tuning of the pre-trained machine learning model, the system calculates a discrepancy value between the first real trajectory and the first simulated trajectory. In response to determining that the discrepancy value is greater than a threshold discrepancy value, the system updates weights of the pre-trained machine learning model and executes the pre-trained machine learning model with the updated weights.

### FIELD OF TECHNOLOGY

The present disclosure relates to the field of machine learning in autonomous vehicles, and, more specifically, to systems and methods for fine-tuning a machine learning model of an autonomous vehicle during specific events.

### BACKGROUND

Autonomous vehicles are at the forefront of transportation innovation, driven by sophisticated algorithms that enable real-time navigation and decision-making. However, these algorithms still have room for improvement. Challenges in perception and sensor fusion, particularly in complex environments, highlight the need for more accurate data processing.

Machine learning models, which underpin many autonomous systems, require optimization to reduce dependency on large datasets and improve learning from real-world experiences. However, there are limits to fine-tuning. For example, constant fine-tuning can lead to overtraining, where models become too tailored to specific datasets and lose generalization capabilities. Fine-tuning also demands significant computational resources, making it impractical to perform continuously.

Addressing these areas through strategic training and testing is essential to enhance the safety, reliability, and efficiency of autonomous vehicles, ultimately paving the way for their widespread adoption.

### SUMMARY

Aspects of the present disclosure describe fine-tuning a machine learning model of an autonomous vehicle to enhance adaptability by using a reward-based system that responds to specific events. Although the examples provided in the present disclosure are applied to race cars on a racetrack, the systems and methods are applicable to any vehicle (e.g., motorbike, plane, boat, etc.) in any environment (e.g., city roads, sky, lake, etc.).

Fine-tuning is triggered only when certain conditions are met, ensuring efficient use of computational resources. One such trigger is when the real trajectory of the vehicle includes complex maneuvers like a snake, turn, or overtaking trajectory, resembling a chicane. In these cases, a negative reward is given if there is a significant discrepancy between the planned and actual trajectories, while a positive reward is provided if the discrepancy is minimal or below a defined threshold.

Another trigger occurs when there is a significant discrepancy in specific parameters such as slippage, run-off, or deviations in position, speed, or acceleration beyond a set threshold. Here, a negative reward is applied proportionally to the discrepancy, and a positive reward is optional if the discrepancy is minimal. This reward-based fine-tuning method allows the model to adapt effectively to the track conditions while conserving computational resources by only engaging in fine-tuning when necessary.

In one exemplary aspect, the techniques described herein relate to a method for fine-tuning a machine learning model of an autonomous vehicle during specific events, the method including: monitoring a vehicle navigating in an environment using a pre-trained machine learning model that is configured to make navigation decisions during autonomous driving of the vehicle; identifying a first simulated trajectory generated by the pre-trained machine learning model and a first real trajectory driven by the vehicle; in response to determining that a trajectory type of the first real trajectory is one of a plurality of trajectory types that trigger fine-tuning of the pre-trained machine learning model, calculating a discrepancy value between the first real trajectory and the first simulated trajectory; in response to determining that the discrepancy value is greater than a threshold discrepancy value, updating weights of the pre-trained machine learning model; and executing the pre-trained machine learning model with the updated weights.

In some aspects, the techniques described herein relate to a method, wherein updating weights of the pre-trained machine learning model includes utilizing reinforcement learning, wherein a negative reward is applied to an action for generating the first simulated trajectory.

In some aspects, the techniques described herein relate to a method, wherein the negative reward is proportional to the discrepancy value.

In some aspects, the techniques described herein relate to a method, further including: in response to determining that the discrepancy value is not greater than the threshold discrepancy value, applying a positive reward to the action for generating the first simulated trajectory.

In some aspects, the techniques described herein relate to a method, further including: identifying a second simulated trajectory generated by the pre-trained machine learning model and a second real trajectory driven by the vehicle; in response to determining that a trajectory type of the second real trajectory is not one of the plurality of trajectory types, not fine-tuning the pre-trained machine learning model.

In some aspects, the techniques described herein relate to a method, wherein the plurality of trajectory types include a sharp turn, a curve, a chicane, and an overtaking.

In some aspects, the techniques described herein relate to a method, further including: identifying a first simulated vehicle parameter generated by the pre-trained machine learning model and a first real vehicle parameter of the vehicle; in response to determining that a parameter type of the first real vehicle parameter is one of a plurality of vehicle parameter types that trigger fine-tuning of the pre-trained machine learning model, calculating another discrepancy value between the first real vehicle parameter and the first simulated vehicle parameter; and in response to determining that the another discrepancy value is greater than another threshold discrepancy value, updating the weights of the pre-trained machine learning model.

In some aspects, the techniques described herein relate to a method, wherein the plurality of vehicle parameter types includes slippage, run-off, position, speed, and acceleration.

In some aspects, the techniques described herein relate to a method, wherein updating the weights of the pre-trained machine learning model includes utilizing reinforcement learning, wherein another negative reward is applied to an action for generating the first simulated vehicle parameter.

In some aspects, the techniques described herein relate to a method, wherein another negative reward is proportional to the discrepancy value.

In some aspects, the techniques described herein relate to a method, further including: in response to determining that another discrepancy value is not greater than another threshold discrepancy value, applying another positive reward to the action for generating the first simulated vehicle parameter.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for fine-tuning a machine learning model of an autonomous vehicle during specific events, including: at least one memory; at least one hardware processor coupled with the at least one memory and configured, individually or in combination, to: monitor a vehicle navigating in an environment using a pre-trained machine learning model that is configured to make navigation decisions during autonomous driving of the vehicle; identify a first simulated trajectory generated by the pre-trained machine learning model and a first real trajectory driven by the vehicle; in response to determining that a trajectory type of the first real trajectory is one of a plurality of trajectory types that trigger fine-tuning of the pre-trained machine learning model, calculate a discrepancy value between the first real trajectory and the first simulated trajectory; in response to determining that the discrepancy value is greater than a threshold discrepancy value, update weights of the pre-trained machine learning model; and execute the pre-trained machine learning model with the updated weights.

In some aspects, the techniques described herein relate to a non-transitory computer readable medium storing thereon computer executable instructions for fine-tuning a machine learning model of an autonomous vehicle during specific events, including instructions for: monitoring a vehicle navigating in an environment using a pre-trained machine learning model that is configured to make navigation decisions during autonomous driving of the vehicle; identifying a first simulated trajectory generated by the pre-trained machine learning model and a first real trajectory driven by the vehicle; in response to determining that a trajectory type of the first real trajectory is one of a plurality of trajectory types that trigger fine-tuning of the pre-trained machine learning model, calculating a discrepancy value between the first real trajectory and the first simulated trajectory; in response to determining that the discrepancy value is greater than a threshold discrepancy value, updating weights of the pre-trained machine learning model; and executing the pre-trained machine learning model with the updated weights.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for fine-tuning a machine learning model of an autonomous vehicle during specific events.

FIG. 2 is a diagram illustrating the specific events that trigger fine-tuning.

FIG. 3 is a block diagram for generating simulated trajectories.

FIG. 4 is a block diagram for performing a discrepancy analysis.

FIG. 5 illustrates a flow diagram of a method for fine-tuning a machine learning model of an autonomous vehicle during specific events.

FIG. 6 presents an example of a general-purpose computer system on which aspects of the present disclosure can be implemented.

### DETAILED DESCRIPTION

Exemplary aspects are described herein in the context of a system, method, and computer program product for fine-tuning a machine learning model of an autonomous vehicle during specific events. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure outlines systems and methods for fine-tuning machine learning models in autonomous vehicles to enhance adaptability through a reward-based system that responds to specific events. As mentioned previously, while the examples focus on race cars navigating a track, these systems and methods are versatile and are applicable to various types of vehicles and environments.

By default, the autonomous vehicle may be equipped with at least one machine learning model configured to perform critical tasks essential for safe and efficient operation. This model may be responsible for detecting obstacles, which involves identifying and classifying various objects in the vehicle's path, such as pedestrians, other vehicles, and road debris. The model may use data from multiple sensors, including cameras, LiDAR, and radar, to create a comprehensive understanding of the surrounding environment.

Furthermore, the model may segment the road ahead by distinguishing between different elements of the roadway, such as lanes, curbs, and traffic signs - enabling the vehicle to maintain its course accurately. This segmentation is for understanding the road layout and making informed navigation decisions. The model may also integrate real-time data to make dynamic navigation decisions, adjusting speed, direction, and trajectory to ensure safe passage through complex traffic scenarios.

As mentioned previously, no model is perfect and there is always room for improvement to ensure passenger and environment safety. A conventional approach to improving model performance may involve fine-tuning the model. However, fine-tuning can be computationally demanding and should be performed only when necessary. In the context of the present disclosure, fine-tuning is strategically triggered only when certain conditions are met, ensuring efficient use of computational resources.

One trigger for fine-tuning occurs when the vehicle's real trajectory involves executing complex maneuvers, such as navigating a snake-like path, making sharp turns, or performing overtaking maneuvers that resemble a chicane. These scenarios demand precise control and adaptability from the vehicle's systems, as they often occur in environments with tight spaces or high-speed conditions, such as racetracks or congested urban roads. During these maneuvers, the vehicle's machine learning model must accurately align the planned trajectory with the actual path taken. If there is a significant discrepancy between the two, indicating that the vehicle is not following the intended course, a negative reward is applied. This negative feedback prompts the model to adjust its parameters and improve its performance. Conversely, if the discrepancy is minimal or falls below a predefined threshold, a positive reward is given. This positive reinforcement encourages the model to continue using the successful strategies it employed during the maneuver. By applying this reward-based system, the vehicle can refine its navigation capabilities, ensuring smoother and more accurate handling of complex driving situations.

Another trigger for fine-tuning is activated when there is a significant discrepancy in specific driving parameters, such as slippage, run-off, or deviations in position, speed, or acceleration, that exceed a predefined threshold. These parameters are crucial for maintaining vehicle stability and ensuring safe navigation. Slippage refers to the loss of traction between the tires and the road, which can lead to skidding or loss of control, especially in adverse weather conditions or on sharp turns. Run-off involves the vehicle veering off its intended path, potentially leading to dangerous situations or off-road excursions. Deviations in position, speed, or acceleration indicate that the vehicle is not adhering to its planned trajectory or operating within safe limits.

When these discrepancies surpass the set threshold, it signals that the vehicle's current model may not be adequately calibrated for the present conditions. In response, a negative reward is applied, proportional to the degree of discrepancy, to encourage the model to adjust and improve its performance. A positive reward is optional if the discrepancy is minimal, reinforcing effective handling. For instance, imagine an autonomous vehicle navigating a sharp curve on a wet road. If the vehicle experiences significant slippage, causing it to drift outside its intended lane, the model detects this discrepancy between the planned and actual trajectory. In response, a negative reward is applied, proportional to the extent of the slippage. This feedback prompts the model to adjust its parameters, such as reducing speed or altering steering inputs, to improve traction and maintain lane position in future similar scenarios. By doing so, the model learns to enhance its performance, ensuring safer and more reliable navigation under challenging conditions.

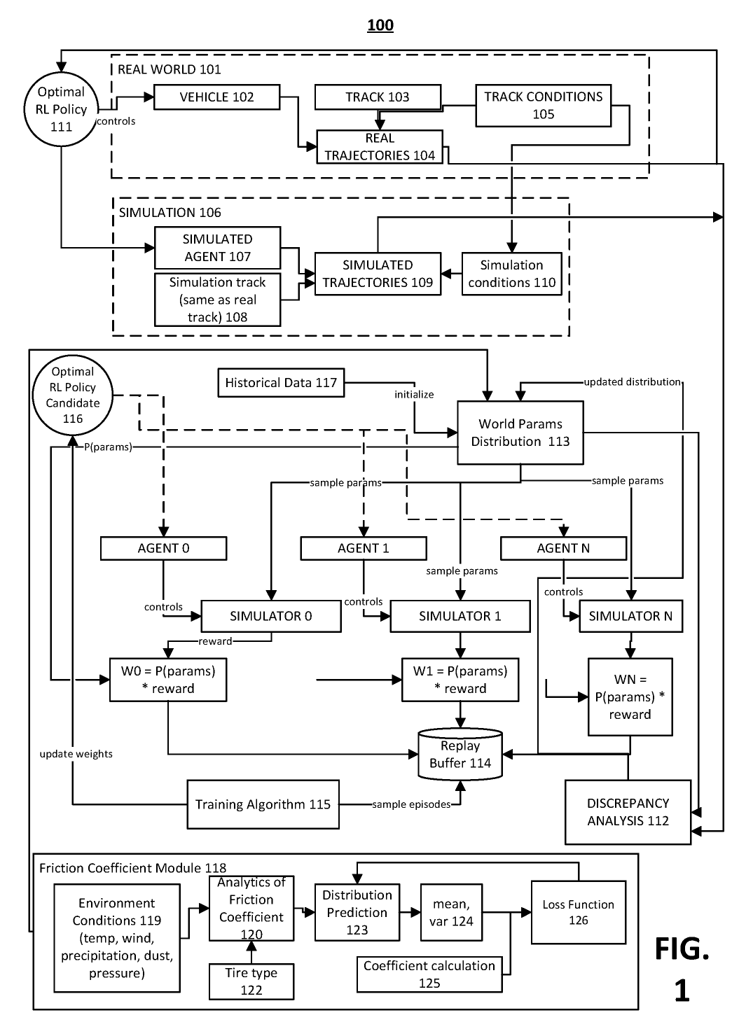

FIG. 1 is a block diagram illustrating system 100 for fine-tuning a machine learning model of an autonomous vehicle during specific events. System 100 first establishes a real-world portion 101 and a simulation portion 106. Real world portion 101 includes vehicle 102 (e.g., the autonomous vehicle such as a race car) traveling in track 103. Real trajectories 104 represents the target trajectories that the machine learning model is supposed to make. Track conditions 105 represent the true conditions of the track (e.g., temperature, weather, road conditions, etc.).

In the simulation portion 106, an optimal reinforcement learning (RL) policy 111 guides the actions of simulated agent 107. The simulation track 108 mirrors track 103 but in a digital format. Simulated trajectories 109 are the paths predicted by the vehicle's machine learning model. Discrepancies between real trajectories 104 and simulated trajectories 109 inform the fine-tuning process. Simulation conditions 110 are the predicted track conditions by the model. It is important to note that the term "machine learning model" may refer to multiple models, each handling different outputs like trajectory, track conditions, and vehicle movement parameters.

Discrepancy analysis 112 is performed on real trajectories 104 and simulated trajectories 109. Based on the discrepancy (e.g., whether the discrepancy is greater than a threshold discrepancy), an updated distribution is provided to world parameters distribution 113. Distribution 113 is initialized using historical data 117.

One example of an input in world parameters distribution 113 is derived from the friction coefficient module 118. This module takes into account various environmental conditions 119, such as temperature, wind speed, precipitation, air quality, and air pressure. These factors significantly influence the friction between the vehicle's tires and the road surface. For instance, rain can reduce friction, making roads slippery and affecting vehicle handling. Additionally, the tire type 122 of vehicle 102, whether it's designed for wet or dry conditions, is also considered.

These inputs are processed in the analytics of friction coefficient 120, which calculates how these conditions impact the vehicle's performance. The output from this analysis is then fed into distribution prediction 123, where statistical measures like the mean and variance 124 are determined. These measures help predict how the vehicle might behave under similar conditions.

Finally, a loss 126 is calculated by comparing the coefficient calculation 125 with the predicted mean and variance 124. This loss indicates the accuracy of the predictions, guiding further adjustments to improve the model's reliability in simulating real-world driving scenarios. For example, if the predicted friction is significantly off from the actual conditions, the model can be fine-tuned to better handle similar situations in the future.

World parameters distribution 113 provides sample parameters to simulators 0, 1, …, N. Each simulator is controlled by an agent (e.g., agents 0, 1, …, N), which is guided by optimal RL policy candidate 116. P(params) are extracted from world parameters distribution 113, which are each multiplied by a reward value. This results in W0, W1, …, WN, each corresponding to a respective simulator. P(params) represent various environmental and vehicle conditions, such as road friction, weather, and vehicle dynamics. For instance, a parameter may simulate wet road conditions, affecting how the vehicle should adjust its speed and handling.

Each parameter set is multiplied by a reward value, resulting in weighted outputs W0, W1, …, WN, corresponding to each simulator. These weights reflect the effectiveness of the agent's actions under the given conditions. For example, if a simulator successfully navigates a sharp turn on a slippery road, the associated reward value would be high, indicating effective decision-making.

Training algorithm 115 samples episodes from replay buffer 114 and updates weights associated with optimal RL policy candidate 116. Each of W0, W1, …, WN is placed in a replay buffer 114. Replay buffer 114 acts as a storage system, holding past experiences or episodes, which include details such as the state of the environment, actions taken, rewards received, and the resulting new states. By sampling episodes from this buffer, the algorithm can break the correlation between consecutive experiences, leading to more stable and efficient learning. These sampled episodes are then used to refine and update the weights of the machine learning model within the optimal RL policy candidate 116. These weights determine how the model predicts actions based on given states. The optimal RL policy candidate 116 represents the current version of the policy that the model is working to optimize. By adjusting these weights, the model improves its decision-making process, aiming to maximize rewards over time. his optimal RL policy candidate 116 is then used as optimal RL policy 111 to guide simulated agent 107 in generating an improved simulated trajectory 109.

This optimal RL policy candidate 116 is then used as optimal RL policy 111 to guide simulated agent 107 in generating an improved simulated trajectory 109.

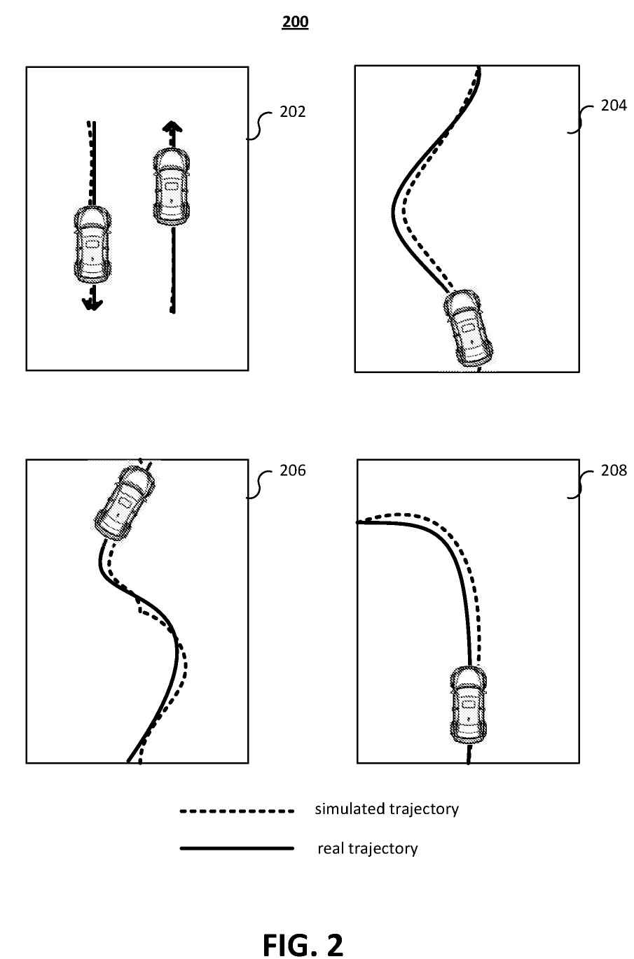

FIG. 2 is a diagram 200 illustrating the specific events that trigger fine-tuning. Event 202 represents straight movements (e.g., forward/reverse along a line) in an overtaking where the car overtakes another car. Event 204 represents a curve. Event 206 represents a snake-like path (e.g., a chicane). Event 208 represents a sharp turn. In each event, the discrepancy between the real trajectory and the simulated trajectory, as calculated during discrepancy analysis 112, may be greater than a threshold discrepancy. This may trigger fine-tuning (e.g., updating optimal RL policy 111).

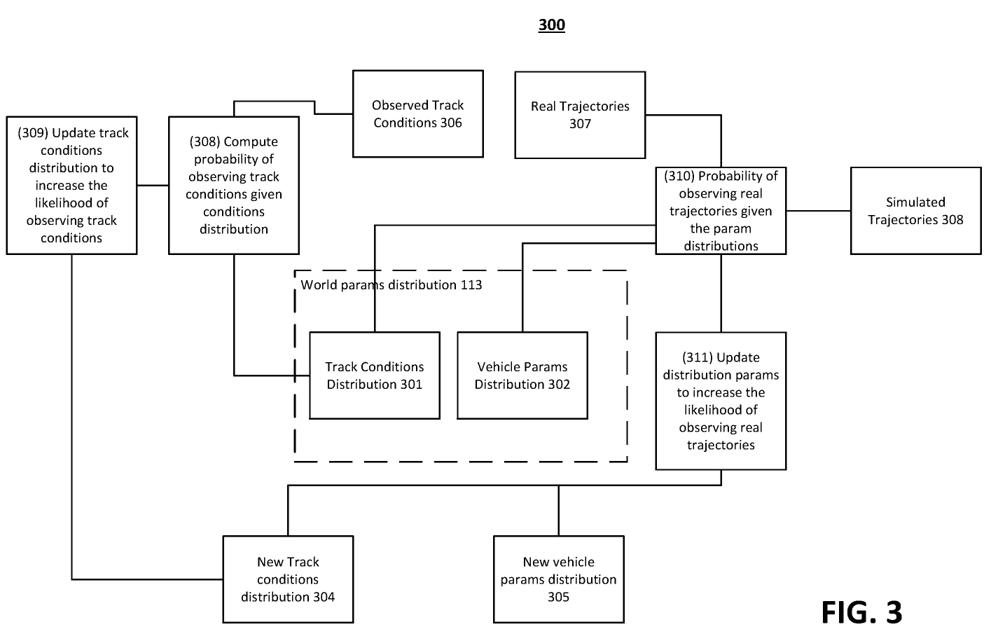

FIG. 3 Is a block diagram 300 for generating simulated trajectories. In world params distribution 113, there are track conditions distribution 301 and vehicle parameters distribution 302. Given observed track conditions 306, at 308, system 100 computes a probability of observing track conditions given conditions distribution. At 309, system 100 updates track conditions distribution to increase the likelihood of observing track conditions 306. This leads to new track conditions distribution 304.

Given real trajectories 307 and simulated trajectories 308, at 310, system 100 computes the probability of observing real trajectories given param distributions. At 311, system 100 updates distribution params to increase the likelihood of observing real trajectories. This yields new vehicle params distribution 305.

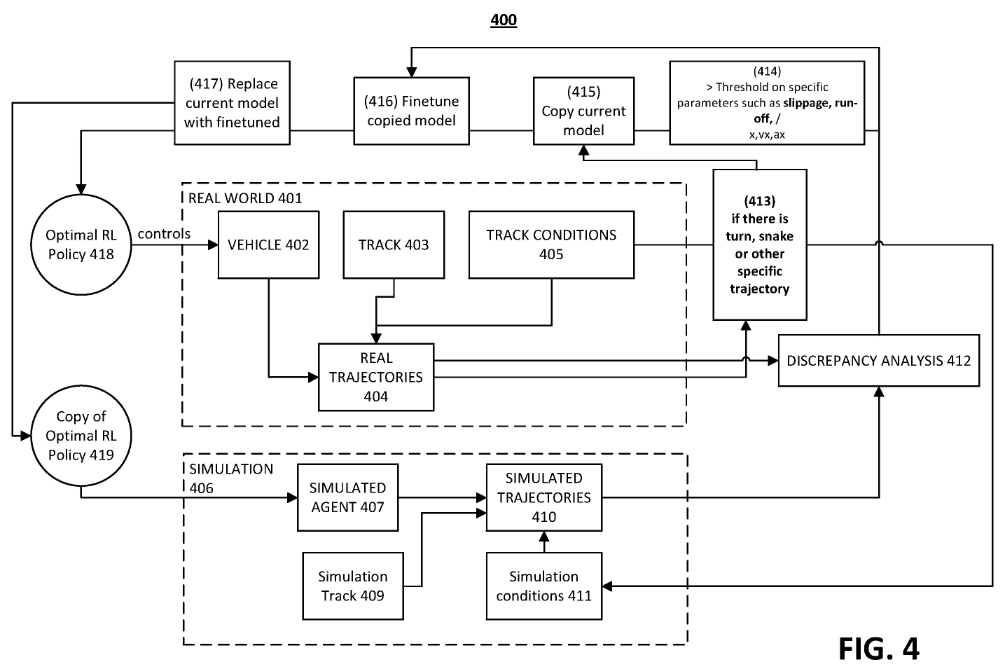

FIG. 4 is a block diagram 400 for performing a discrepancy analysis. In real world 401, vehicle 402 drives on track 403 along real trajectories 404 and under track conditions 405. In simulation 406, simulated agent 407 creates simulated trajectories 410 on simulation track 409 under simulated track conditions 411.

At 413, system 100 may detect a specific type of trajectory. This triggers fine-tuning. More specifically, discrepancy analysis 412 compares the trajectories and at 414, determines whether certain parameters have a discrepancy. For example, the location/path of the vehicle may be different. The expected vehicle parameters may also be different beyond a threshold difference. This causes the current pre-trained machine learning model to be copied at 415. At 416, the copied model is finetuned. At 417, the current model is replaced by the fine-tuned model. Optimal reinforcement learning policy 418 is then shared with vehicle 402 and a copy of the policy (i.e., policy 419) is shared with simulated agent 407.

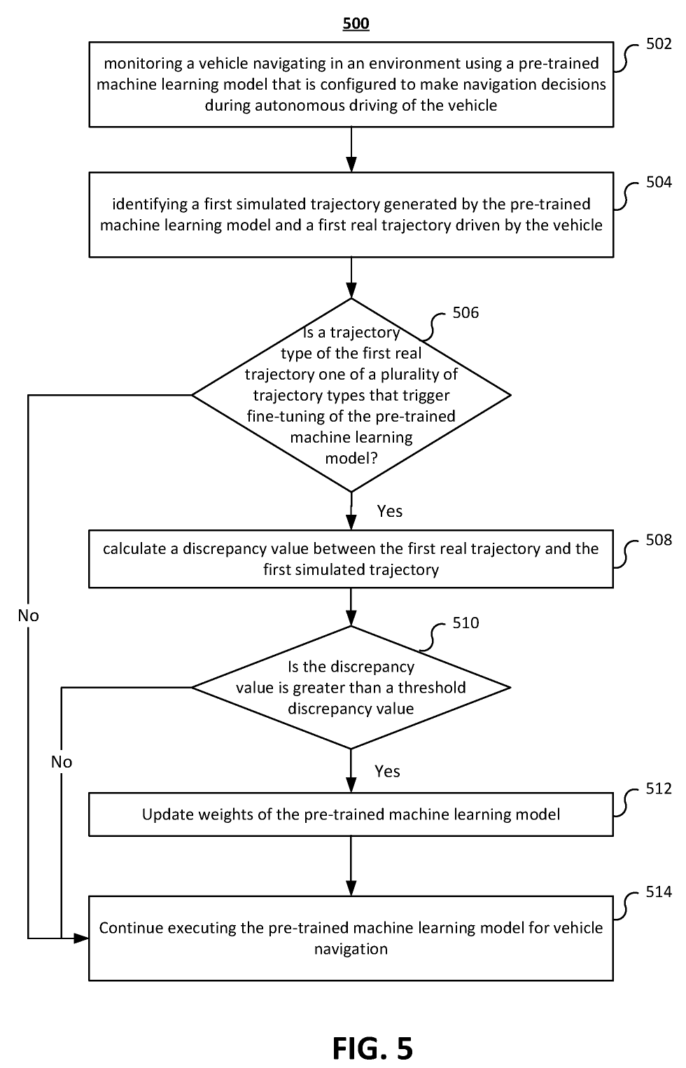

FIG. 5 illustrates a flow diagram of method 500 for fine-tuning a machine learning model of an autonomous vehicle during specific events. At 502, system 100 monitors a vehicle (e.g., vehicle 102) navigating in an environment (e.g., track 103) using a pre-trained machine learning model that is configured to make navigation decisions during autonomous driving of the vehicle. For example, system 100 comprises an array of sensors, including cameras, LIDAR, radar, and GPS units, which collectively gather comprehensive data about the vehicle's surroundings and internal state. For instance, cameras provide real-time video feeds of the road, while LIDAR offers detailed 3D mapping of the environment. Vehicle 102 may be a prototype or a production model, such as a Tesla Model S equipped with the latest Autopilot hardware, capable of supporting autonomous operations. The environment, exemplified by track 103, may be a controlled test track that simulates various driving conditions, such as urban streets, highways, or rural roads, featuring elements like intersections, pedestrian crossings, and varying speed limits to mimic real-world scenarios. The pre-trained machine learning model is developed using extensive datasets of driving scenarios and is adept at making critical decisions such as lane keeping, obstacle avoidance, and speed adjustments.

At 504, system 100 identifies a first simulated trajectory (e.g., of simulated trajectories 109) generated by the pre-trained machine learning model and a first real trajectory (e.g., of real trajectories 104) driven by the vehicle. For example, the first simulated trajectory may the dotted line in event 204 of FIG. 2 and the first real trajectory may be the solid line in event 204. The first simulated trajectory is the path that the pre-trained machine learning model recommends and expects the vehicle to take at a specific period of time, and the first real trajectory is the path the vehicle actually took during this specific period of time. It should be noted that the vehicle is attempting to traverse the path along the first simulated trajectory but may be unable to because of real world factors that the simulation failed to recognize.

At 506, system 100 determines whether a trajectory type of the first real trajectory is one of a plurality of trajectory types that trigger fine-tuning of the pre-trained machine learning model. In some aspects, the plurality of trajectory types includes a sharp turn, a curve, a chicane, and an overtaking. For instance, a sharp turn may occur on a winding mountain road where precise steering and speed adjustments are critical to maintaining control and safety. Similarly, navigating a curve requires the model to predict the vehicle's path accurately and adjust its trajectory to prevent understeering or oversteering. A chicane, often found on racing tracks, involves a quick succession of tight turns in opposite directions, demanding rapid and precise decision-making from the model to maintain optimal speed and stability. Overtaking, another complex maneuver, requires the model to assess the speed and position of surrounding vehicles, determine the appropriate moment to change lanes, and execute the maneuver safely without disrupting the flow of traffic.

In response to determining that the trajectory type is one of the pluralities of trajectory types predefined for triggering a potential fine-tuning of the pre-trained machine learning model, method 500 advances to 508, where system 100 calculates (e.g., using discrepancy analysis 112) a discrepancy value between the first real trajectory and the first simulated trajectory. This calculation quantifies the difference between the vehicle's actual path and the path predicted by the model, thereby identifying areas where the model's performance may be lacking. For instance, consider a scenario where the real trajectory involves a sharp turn. The real trajectory might be represented by a set of coordinates (x1, y1), (x2, y2), ..., (xn, yn) that the vehicle follows in real-time. Meanwhile, the simulated trajectory, predicted by the model, might be represented by another set of coordinates (x1', y1'), (x2', y2'), ..., (xn', yn').

The discrepancy value can be calculated using various mathematical methods, such as the Euclidean distance between corresponding points on the real and simulated trajectories. The overall discrepancy value may be the sum or average of these individual discrepancies across all points. A high discrepancy value indicates significant deviation, suggesting that the model may require fine-tuning to better handle the specific trajectory type. By systematically analyzing these discrepancies, system 100 can identify patterns or conditions under which the model's predictions are less accurate, thereby guiding the fine-tuning process to enhance the model's performance in real-world driving scenarios.

At 510, system 100 determines whether the discrepancy value is greater than a threshold discrepancy value. In response to determining that the discrepancy value is greater than the threshold discrepancy value, method 500 advances to 512, where system 100 updates weights of the pre-trained machine learning model. In some aspects, the weight adjustment process involves using the discrepancy data to perform backpropagation. For instance, consider a scenario where the model consistently underestimates the sharpness of a turn, leading to a high discrepancy value. By analyzing the error patterns, system 100 can identify which specific weights in the neural network are contributing to the inaccurate predictions. These weights are then adjusted to reduce the error in future predictions. This might involve increasing the sensitivity of certain neurons to input features related to road curvature or vehicle dynamics. Through this iterative process of weight updating, the model becomes more adept at handling the specific trajectory types that initially triggered the fine-tuning process.

In some aspects, during training system 100 adjusts the learning rate within a range for updating weights (e.g., from 3e-4 to 1e-3) depending on the level of discrepancy. In some aspects, in cases of a high angle (up to 180 degrees) between gradients, the learning rate is increased.

Subsequent to 512, method 500 advances to 514, where system 100 continues to execute the pre-trained machine learning model for vehicle navigation. In this case, the pre-trained machine learning model has been fine-tuned such that the discrepancy values for the same trajectories will be less than the threshold discrepancy value. For example, if the vehicle was to drive along the same path again, the simulated trajectory will be closer to the real trajectory of the vehicle.

Suppose that at 506 and 510, system 100 determines that the trajectory type is not one of the pluralities of trajectory types or the discrepancy value is not greater than the threshold discrepancy value, respectively. In these cases, method 500 skips the fine-tuning steps and proceeds to 514 - executing the pre-trained machine learning model as-is.

In some aspects, updating weights of the pre-trained machine learning model comprises utilizing reinforcement learning, wherein a negative reward is applied to an action for generating the first simulated trajectory (which is inaccurate and led to high discrepancy value). For example, if the model predicted a trajectory that deviated significantly from the real path during a sharp turn, resulting in a high discrepancy value, a negative reward would be assigned to the decision-making process that led to this prediction.

In some aspects, wherein the negative reward is proportional to the discrepancy value. In other words, larger discrepancies result in more substantial penalties. This proportionality ensures that the model is more strongly incentivized to correct larger errors, thereby prioritizing improvements in areas where its predictions are most inaccurate. For instance, if the discrepancy value is 10, the negative reward might be twice as severe as when the discrepancy is 5, reflecting the greater need for correction.

In some aspects, the decision-making is in a constant state of fine-tuning as long as the trajectory type is one of the pluralities of trajectory types. For example, if at 510, system 100 determines that the discrepancy value is not greater than the threshold discrepancy value, system 100 may apply a positive reward to the action for generating the first simulated trajectory. The application of positive rewards enables the model to maximize cumulative rewards by repeating successful actions. This approach not only solidifies effective decision-making patterns but also enhances the model's confidence in handling similar trajectory types. By continuously fine-tuning the model through both positive and negative reinforcement, system 100 ensures that the autonomous vehicle can maintain high levels of accuracy and reliability across a wide range of driving conditions.

In some aspects, after 514, system 100 identifies a second simulated trajectory generated by the pre-trained machine learning model and a second real trajectory driven by the vehicle. In response to determining that a trajectory type of the second real trajectory is not one of the pluralities of trajectory types, system 100 may not fine-tune the pre-trained machine learning model. This feature returns the emphasis on selecting the trajectory types that actually trigger fine-tuning. If the vehicle is simply moving straight, for example, there may be no need to re-train the model.

In some aspects, system 100 may identify a first simulated vehicle parameter generated by the pre-trained machine learning model and a first real vehicle parameter of the vehicle. In some aspects, the plurality of vehicle parameter types includes slippage, run-off, position, speed, and acceleration. For example, slippage may refer to the vehicle's tires losing grip on the road surface, which is critical to monitor in conditions like rain or ice. Run-off may involve the vehicle veering off the intended path, which is particularly important in scenarios involving sharp turns or evasive maneuvers. Position refers to the vehicle's location on the road, while speed and acceleration are fundamental parameters that influence the vehicle's dynamics and safety.

In response to determining that a parameter type of the first real vehicle parameter is one of a plurality of vehicle parameter types that trigger fine-tuning of the pre-trained machine learning model, system 100 calculates another discrepancy value between the first real vehicle parameter and the first simulated vehicle parameter. In response to determining that another discrepancy value is greater than another threshold discrepancy value, system 100 updates the weights of the pre-trained machine learning model. For instance, if the real vehicle's speed is significantly higher than the simulated speed during a particular maneuver, this discrepancy could indicate that the model is not accurately accounting for factors like road gradient or wind resistance. In some aspects, again, updating the weights of the pre-trained machine learning model comprises utilizing reinforcement learning. In this case, system 100 may apply another negative reward to an action for generating the first simulated vehicle parameter. In some aspects, another negative reward is proportional to the discrepancy value. On the other hand, in response to determining that another discrepancy value is not greater than another threshold discrepancy value, system 100 applies another positive reward to the action for generating the first simulated vehicle parameter.

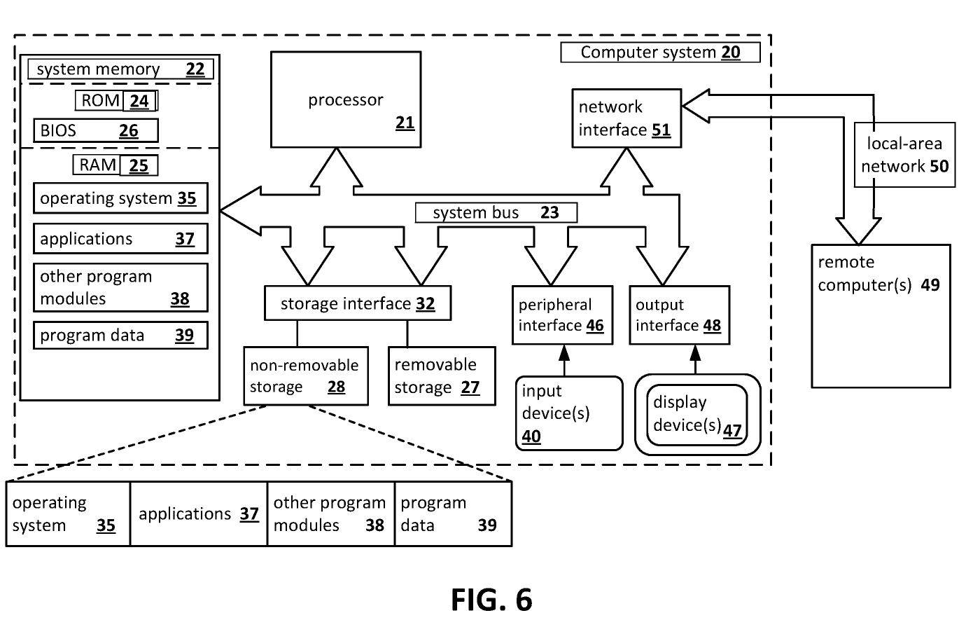

FIG. 6 is a block diagram illustrating a computer system 20 on which aspects of systems and methods for fine-tuning a machine learning model of an autonomous vehicle during specific events may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object-oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for fine-tuning a machine learning model of an autonomous vehicle during specific events, the method comprising:
monitoring a vehicle navigating in an environment using a pre-trained machine learning model that is configured to make navigation decisions during autonomous driving of the vehicle;
identifying a first simulated trajectory generated by the pre-trained machine learning model and a first real trajectory driven by the vehicle;
in response to determining that a trajectory type of the first real trajectory is one of a plurality of trajectory types that trigger fine-tuning of the pre-trained machine learning model, calculating a discrepancy value between the first real trajectory and the first simulated trajectory;
in response to determining that the discrepancy value is greater than a threshold discrepancy value, updating weights of the pre-trained machine learning model; and
executing the pre-trained machine learning model with the updated weights.

2. The method of claim 1, wherein updating weights of the pre-trained machine learning model comprises utilizing reinforcement learning, wherein a negative reward is applied to an action for generating the first simulated trajectory.

3. The method of claim 2, wherein the negative reward is proportional to the discrepancy value.

4. The method of claim 2, further comprising:
in response to determining that the discrepancy value is not greater than the threshold discrepancy value, applying a positive reward to the action for generating the first simulated trajectory.

5. The method of claim 1, further comprising:
identifying a second simulated trajectory generated by the pre-trained machine learning model and a second real trajectory driven by the vehicle;
in response to determining that a trajectory type of the second real trajectory is not one of the plurality of trajectory types, not fine-tuning the pre-trained machine learning model.

6. The method of claim 1, wherein the plurality of trajectory types include a sharp turn, a curve, a chicane, and an overtaking.

7. The method of claim 1, further comprising:
identifying a first simulated vehicle parameter generated by the pre-trained machine learning model and a first real vehicle parameter of the vehicle;
in response to determining that a parameter type of the first real vehicle parameter is one of a plurality of vehicle parameter types that trigger fine-tuning of the pre-trained machine learning model, calculating another discrepancy value between the first real vehicle parameter and the first simulated vehicle parameter; and
in response to determining that the another discrepancy value is greater than another threshold discrepancy value, updating the weights of the pre-trained machine learning model.

8. The method of claim 7, wherein the plurality of vehicle parameter types includes slippage, run-off, position, speed, and acceleration.

9. The method of claim 7, wherein updating the weights of the pre-trained machine learning model comprises utilizing reinforcement learning, wherein another negative reward is applied to an action for generating the first simulated vehicle parameter.

10. The method of claim 9, wherein the another negative reward is proportional to the discrepancy value.

11. The method of claim 9, further comprising:
in response to determining that the another discrepancy value is not greater than the another threshold discrepancy value, applying another positive reward to the action for generating the first simulated vehicle parameter.

12. A system for fine-tuning a machine learning model of an autonomous vehicle during specific events, comprising:
at least one memory;
at least one hardware processor coupled with the at least one memory and configured, individually or in combination, to:
monitor a vehicle navigating in an environment using a pre-trained machine learning model that is configured to make navigation decisions during autonomous driving of the vehicle;
identify a first simulated trajectory generated by the pre-trained machine learning model and a first real trajectory driven by the vehicle;
in response to determining that a trajectory type of the first real trajectory is one of a plurality of trajectory types that trigger fine-tuning of the pre-trained machine learning model, calculate a discrepancy value between the first real trajectory and the first simulated trajectory;
in response to determining that the discrepancy value is greater than a threshold discrepancy value, update weights of the pre-trained machine learning model; and
execute the pre-trained machine learning model with the updated weights.

13. The system of claim 12, wherein the at least one hardware processor is further configured to update weights of the pre-trained machine learning model by utilizing reinforcement learning, wherein a negative reward is applied to an action for generating the first simulated trajectory.

14. The system of claim 13, wherein the negative reward is proportional to the discrepancy value.

15. The system of claim 13, wherein the at least one hardware processor is further configured to:
in response to determining that the discrepancy value is not greater than the threshold discrepancy value, apply a positive reward to the action for generating the first simulated trajectory.

16. The system of claim 12, wherein the at least one hardware processor is further configured to:
identify a second simulated trajectory generated by the pre-trained machine learning model and a second real trajectory driven by the vehicle;
in response to determining that a trajectory type of the second real trajectory is not one of the plurality of trajectory types, not fine-tune the pre-trained machine learning model.

17. The system of claim 12, wherein the plurality of trajectory types include a sharp turn, a curve, a chicane, and an overtaking.

18. The system of claim 12, wherein the at least one hardware processor is further configured to:
identify a first simulated vehicle parameter generated by the pre-trained machine learning model and a first real vehicle parameter of the vehicle;
in response to determining that a parameter type of the first real vehicle parameter is one of a plurality of vehicle parameter types that trigger fine-tuning of the pre-trained machine learning model, calculate another discrepancy value between the first real vehicle parameter and the first simulated vehicle parameter; and
in response to determining that the another discrepancy value is greater than another threshold discrepancy value, update the weights of the pre-trained machine learning model.

19. The system of claim 18, wherein the plurality of vehicle parameter types includes slippage, run-off, position, speed, and acceleration.

20. A non-transitory computer readable medium storing thereon computer executable instructions for fine-tuning a machine learning model of an autonomous vehicle during specific events, including instructions for:
monitoring a vehicle navigating in an environment using a pre-trained machine learning model that is configured to make navigation decisions during autonomous driving of the vehicle;
identifying a first simulated trajectory generated by the pre-trained machine learning model and a first real trajectory driven by the vehicle;
in response to determining that a trajectory type of the first real trajectory is one of a plurality of trajectory types that trigger fine-tuning of the pre-trained machine learning model, calculating a discrepancy value between the first real trajectory and the first simulated trajectory;
in response to determining that the discrepancy value is greater than a threshold discrepancy value, updating weights of the pre-trained machine learning model; and
executing the pre-trained machine learning model with the updated weights.
